(19) United States
(12) Patent Application Publication
(10) Pub. No.: US 2009/0277226 A1
(43) Pub. Date: Nov. 12, 2009

(54) MODULAR MELTER

(76) Inventors: Salvatore R. Santangelo, South Windsor, CT (US); Steven D. Hummel, Newark, OH (US)

Correspondence Address: Ballard Spahr LLP, SUITE 1000, 999 PEACHTREE STREET, ATLANTA, GA, 30309-3915, US

(21) Appl. No.: 12/252,980

(22) Filed: Oct. 16, 2008

Related U.S. Application Data
(60) Provisional application No. 60/980,284, filed on Oct. 16, 2007.

(51) Int. Cl. C03B 5/00; C03B 5/435

(52) U.S. Cl. 65/181; 65/356

(57) ABSTRACT

A method and system that uses a cold wall furnace for melting the materials that are feed into the furnace. In one aspect, at least a portion of the exterior surface of the cold wall furnace is surrounded by at least one jacket configured to transfer heat away from the metal liner of the furnace. This cooling causes the molten glass to solidify on the metal surface of the metal liner of the cold wall furnace, which acts to protect the metal liner of the furnace from oxidation during molten glass evacuation and subsequent exposure to atmosphere.

This application claims the benefit of the filing date of U.S. provisional application Ser. No. 60/980,284 entitled “MODULAR MELTER,” which was filed on Oct. 16, 2007 and which is herein incorporated by reference.

### FIELD OF THE INVENTION

The field of this invention relates generally to glass making, and more particularly to a modular melter for a glass making furnace system.

### BACKGROUND

Conventionally, a melter and refiner are integrated into one unit, which means raw material must be added to keep a steady level in the refiner in order to pull glass out of the system. Problematically, the coupling of the melter and the refiner prohibit the shutting off of energy required by the melter. Additionally the melter/refiner contain a large amount of molten glass which must be kept hot in order not to solidify and ruin the system, which wastes energy and exhausts unnecessary material and/or pollutants into the atmosphere when its not needed by the supply demand on the conventional system The conventional systems must be sized to meet peak demands because the conventional systems lack the capability to add and or delete capacity. This lack of flexibility drives energy usage and stack discharges; more often than not wastefully.

### SUMMARY

In response to the deficiencies of the prior art, the present invention relates to a glass melting vessel and means for controlling the flow of molten glass therefrom the melting vessel without having to maintain a large hot bath of molten glass. More particularly, to a method and system that uses a cold wall furnace for melting the materials that are feed into the furnace. In one aspect, at least a portion of the exterior surface of the cold wall furnace is surrounded by at least one jacket, which defines an internal cavity that is filled with a thermally conductive fluid, such as, for example and without limitation, a glycol/water mixture. In one aspect, the jacket(s) are configured to transfer heat away from the metal liner of the furnace. This cooling causes a portion of the molten glass to solidify on the metal surface of the metal liner of the cold wall furnace, which acts to protect the metal liner of the furnace from oxidation during molten glass evacuation and subsequent exposure to atmosphere.

In various exemplary aspects, heating of the materials that are feed into the interior of the melting vessel can be accomplished via electrical induction through the vessel or via electrodes either through the side or bottom of the furnace. Optionally, additional heating augmentation can be provided using OXY-GAS burners, or the like, that can be strategically positioned substantially adjacent the vessel.

Other apparatus, methods, and aspects and advantages of the invention will be discussed with reference to the Figures and to the detailed description of the preferred embodiments.

### BRIEF DESCRIPTION OF THE DRAWINGS

The accompanying drawings, which are incorporated in and constitute a part of this specification, illustrate several aspects described below and together with the description, serve to explain the principles of the invention. Like numbers represent the same elements throughout the figures.

FIG. 1 is a schematic view of one embodiment of the present invention for a modular melter.

FIG. 2 is a schematic view of one embodiment of an automated thermal valve for the modular melter of FIG. 1.

FIG. 3 is a schematic view of one embodiment for a glass making system showing a plurality of modular melters of FIG. 1 operationally coupled to a conventional glass refiner, which is, in turn, operatively coupled to a plurality of conventional glass feeders that feed glass production lines.

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a melter” can include two or more such melters unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

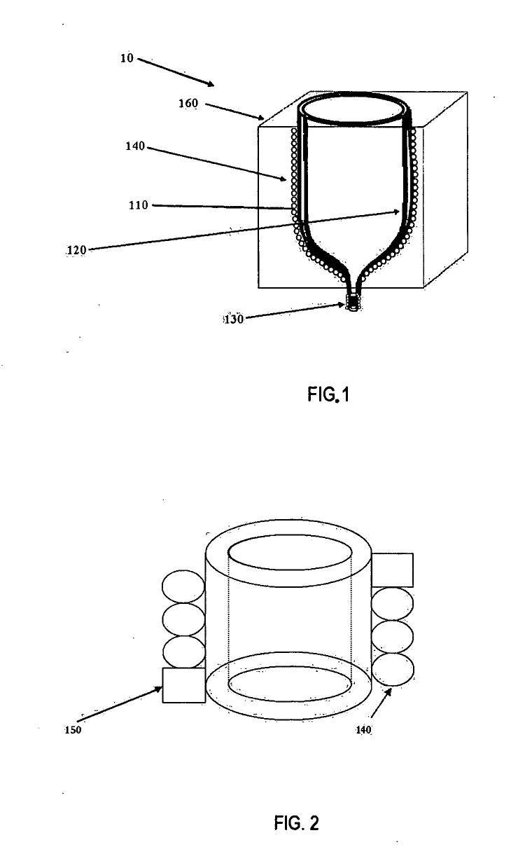

The present invention relates to a glass melting system 10 and means for controlling the flow of molten glass therefrom the melting vessel. More particularly, to a method and system that uses a cold wall furnace 100 for melting the materials that are feed into the furnace 100. Referring to FIG. 1, in one aspect, at least a portion of the exterior surface of the cold wall furnace is surrounded by at least one jacket 110, which defines an internal cavity that is filled with a thermally conductive fluid, such as, for example and without limitation, a glycol/water mixture. In one aspect, the jacket(s) 110 are configured to transfer heat away from the metal liner 120 of the furnace. This cooling causes a portion of the molten glass to solidify on the metal surface of the metal liner 120 of the cold wall furnace, which acts to protect the metal liner of the furnace from oxidation during molten glass evacuation and subsequent exposure to atmosphere. In a further aspect, it is contemplated that the furnace 100 itself may be positioned within an outer furnace casing 160. In one aspect, the outer furnace casing can comprise molybdenum, copper, methylsilazane, or the like.

In various aspects, heating of the materials that are feed into the interior of the melting vessel can be accomplished via electrical induction through the vessel or via electrodes 150 either through the side or bottom of the furnace. In one aspect, induction heating coils 140 can be positioned substantially adjacent the vessel. Optionally, heating augmentation can be provided using OXY-GAS burners, or the like, that can be strategically positioned substantially adjacent the vessel.

Referring now to FIG. 2, one exemplary embodiment for controlling the flow of molten glass therefrom the melting vessel may comprise a thermal flow valve 130 that is automatically controlled by a closed loop feed-back system made primarily of a semi-precious metal, such as, and without limitation, platinum, that is configured to control the flow of molten glass from 0-100% flow. In one aspect, the flow valve 130 can be cooled and the molted glass within the valve can be heated similar to the description for the melting vessel described above. For example and without limitation, the valve may comprise heating coils 140, electrode fired heating 150, OXY-GAS heating, and the like. In one example, the flow valve is mounted to a bottom portion of the melting vessel. In operation, materials that are feed into the melting vessel are heated until they reach a homogenous temperature. Subsequently, the molten material is drained out of the interior volume of the furnace via the thermal flow valve and into a distribution tube that allows the molten glass to flow via gravity into a conventional refining vessel.

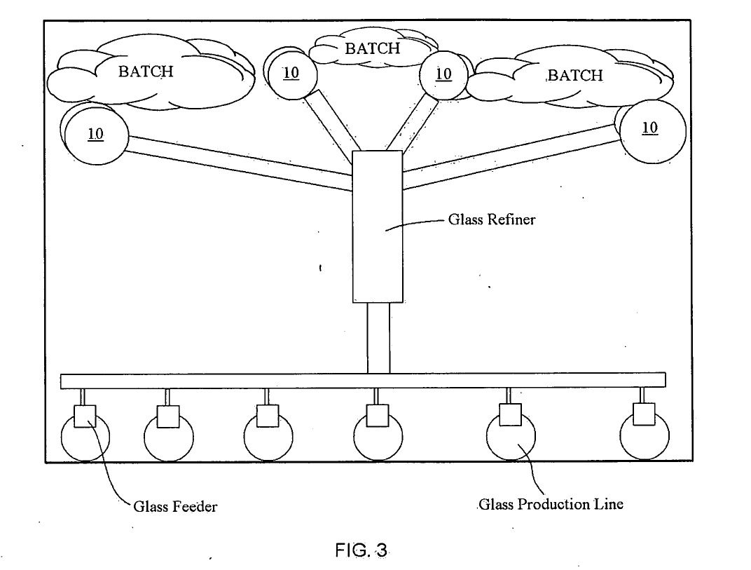

Referring to FIG. 3, the exemplary modular design of the system described above allows for the addition or deletion of melting vessels as required to meet the supply demands. In this exemplary aspect, the system comprises a plurality of the modular melters as described herein, each in fluid communication with a conventional glass refiner. In this aspect, the refiner feeds molten glass to a plurality of conventional glass feeders that, in turn, feed glass production lines. When not in use, the system of the present invention will allow for all power used for selected modular melters to be switched off, which saves energy and minimizes the discharge of exhaust gasses to the atmosphere, thereby resulting in lower operating costs.

Further, in one aspect, the system of the present invention allows for the continuous batch feeding of raw material via the top of the melt vessel with the addition of refractory material from the melt line to the top of the vessel. This agility will allow for the continuous delivery of molten glass via a “cold top” process if the supply demands placed on the process require the use of such a process.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is therefore understood that the invention is not limited to the specific embodiments disclosed herein, and that many modifications and other embodiments of the invention are intended to be included within the scope of the invention. Moreover, although specific terms are employed herein, they are used only in a generic and descriptive sense, and not for the purposes of limiting the described invention.

We claim:

1. A modular glass melter, comprising:
a furnace defining an interior volume;
a means for heating the interior volume;
a jacket surrounding at least a portion of an exterior surface of the furnace, wherein the jacket defines an interior cavity, and wherein the internal cavity is at least partially filled with a thermally conductive fluid; and
a valve in communication with the interior volume of the furnace configured to regulate the flow of molten glass out of the interior volume of the furnace.

2. The modular glass melter of claim 1, wherein the furnace is substantially positioned within a furnace casing.

3. The modular glass melter of claim 2, wherein the furnace casing comprises Molybdenum.

4. The modular glass melter of claim 2, wherein the furnace casing comprises Copper.

5. The modular glass melter of claim 2, wherein the furnace casing comprises Methylsilazane.

6. The modular melter of claim 1, further comprising a closed loop feedback system configured to control the valve.

7. The modular melter of claim 6, wherein the valve comprises a precious metal.

8. The modular melter of claim 7, wherein the precious metal comprises Platinum.

9. The modular melter of claim 1, wherein the valve defines an interior passageway, and wherein the valve comprises a means for heating the interior passageway.

10. The modular melter of claim 7, wherein the valve is mounted thereto a bottom portion of the furnace.

11. The modular melter of claim 1, wherein the thermally conductive fluid comprises a glycol and water mixture.

12. A system for making glass, comprising:
a plurality of modular melters, each modular melter comprising:
a furnace defining an interior volume;
a means for heating the interior volume;
a jacket surrounding at least a portion of an exterior surface of the furnace, wherein the jacket defines an interior cavity, and wherein the internal cavity is at least partially filled with a thermally conductive fluid; and
a valve in communication with the interior volume of the furnace configured to regulate the flow of molten glass out of the interior volume of the furnace.
a glass refiner in fluid communication with each of the modular melters; and
a plurality of glass feeders in fluid communication with the glass refiner.
